(19) United States
(12) Patent Application Publication
(10) Pub. No.: US 2026/0087468 A1
(43) Pub. Date: Mar. 26, 2026

(54) Unified Interoperable Payment System for Cost-Effective Real-Time Financial Transactions

(71) Applicant: PRITHVISH RAKESH DOSHI, VADODARA (IN)

(72) Inventor: PRITHVISH RAKESH DOSHI, VADODARA (IN)

(21) Appl. No.: 19/339,245

(22) Filed: Sep. 24, 2025

Related U.S. Application Data
(60) Provisional application No. 63/699,315, filed on Sep. 26, 2024.

(51) Int. Cl. G06Q 20/08; G06Q 20/02; G06Q 20/38

(52) U.S. Cl. CPC G06Q 20/0855; G06Q 20/023; G06Q 20/3829; G06Q 20/385

(57) ABSTRACT

A computing system executes real-time transactions across multiple settlement rails through a unified API. A transaction request includes a dynamic alias token validated by an HSM and expiring within 30 seconds. Canonical fields are mapped into ISO 20022 PACS.008.001.08, with a compliance code embedded in SplmtryData. The system computes rail health scores every 500 ms and retransmits the same EndToEndId-identified message to alternate rails if acknowledgments exceed 150 ms or availability falls below a threshold. Transactions may be initiated using dynamic scannable codes. The architecture supports replay protection, ISO and non-ISO translations, and optional modules for cross-border or programmable settlement.

### CROSS-REFERENCE TO RELATED APPLICATIONS

This application claims the benefit of U.S. Provisional Patent Application No. 63/699,315, filed on Sep. 26, 2024, entitled “Unified Interoperable Payment System for Cost-Effective Real-Time Financial Transactions”, under 35 U.S.C. § 119 (e). The entire disclosure of the provisional application is incorporated herein by reference.

### REFERENCES TO RELATED PATENT LITERATURE AND PUBLICATIONS

The following prior art patent publications and industry standards are referenced in this application and are incorporated herein by reference to the extent permissible under U.S. law:
US20170221066A1—Real-time payment system and method utilizing prefunded accounts, published Aug. 3, 2017.
US20140172531A1—Performing transactions using QR codes, published Jun. 19, 2014.
WO2014119963A1—Instant payment system and method using QR codes, published Aug. 7, 2014.
US20230259915A1—Cross-service peer-to-peer payment platforms and methods, published Aug. 17, 2023.
U.S. Pat. No. 11,734,658B2—Transactions between services in a multi-tenant architecture (PayPal), issued Aug. 22, 2023.
U.S. Pat. No. 11,336,453B2—Systems and methods for token-based access across service platforms, issued May 17, 2022.
U.S. Pat. No. 8,725,576B2—Remote transaction processing with multiple payment methods, issued May 13, 2014.
US20230133158A1—System and method for conducting secure financial electronic transactions, published May 4, 2023.

In addition, the following industry standards and public references are noted for context:
Federal Reserve FedNow℠ Service Technical Documentation (2023), describing ISO 20022-based instant settlement messaging.
The Clearing House RTP® Network Documentation (2017-present).
European Payments Council (EPC) SEPA Instant Credit Transfer Implementation Guidelines (latest version 2023).
European Payments Council QR Code Guidelines for SEPA Credit Transfers (2020).
BharatQR Standardization Framework (NPCI, Visa, Mastercard, American Express, 2017).
Faster Payments Council QR Code White Paper (2022).

### BACKGROUND OF THE INVENTION

### 1. Problem Statement

Modern commerce demands real-time, secure, and universally interoperable payment mechanisms. Consumers expect the ability to transfer funds instantly, merchants require predictable settlement and low fees, and financial institutions must comply with stringent regulatory frameworks. Yet the global payment infrastructure remains fragmented and inconsistent.

In the United States, the traditional backbone, Automated Clearing House (ACH), wire transfers, and card networks, was built for batch processing. These systems introduce delays of one to three business days, impose fees ranging from 2.5% to 4% on merchants, and require proprietary integrations. The fragmentation forces merchants to choose between costly legacy networks and rail-specific real-time services, none of which interoperate seamlessly.

From the consumer perspective, payment initiation is equally inconsistent. Some systems rely on manual entry of account details, others require card swipes or NFC hardware, and newer methods rely on QR codes or aliases. These mechanisms often expose sensitive financial data or require merchants to invest in dedicated hardware upgrades.

The lack of a rail-agnostic, tokenized, standardized system leads to:
higher costs,
increased fraud exposure,
compliance inefficiencies, and
barriers to adoption for small and medium-sized enterprises.

### 2. Discussion of Conventional Approaches

a. Legacy Payment Systems

ACH transfers, domestic wire payments, and card networks remain the dominant payment methods in the U.S. These are batch-based systems, with settlement delays ranging from one to three business days. Merchants incur high transaction fees, and reconciliation is complex. Critically, these systems require exposure of account or card details to counterparties, creating security risks.

b. U.S. Real-Time Payment Networks

### The Clearing House RTP® Network (2017)

The RTP network enables real-time settlement between participating financial institutions. It provides credit transfer capabilities, request-for-payment functionality, and ISO 20022-based messaging. However, it is limited to participating institutions, requires direct integration with RTP APIs, and provides no fallback to alternate rails when unavailable.

### Federal Reserve FedNow℠ Service (2023)

FedNow is a 24×7×365 real-time gross settlement service that mandates the use of ISO 20022 message formats. While FedNow offers a government-operated instant rail, it similarly requires dedicated integration and provides no abstraction layer for merchants or developers to route across other rails such as RTP or ACH. It also does not inherently solve the tokenization of identifiers or merchant hardware limitations.

c. International Real-Time Schemes

### SEPA Instant Credit Transfer (SCT Inst)

The European Payments Council established SCT Inst to provide euro-denominated instant payments. Transactions are settled within ten seconds and governed by ISO 20022 standards. However, SCT Inst is restricted to eurozone participants and functions only within its designated rail.

### BharatQR (India, 2017)

BharatQR is an interoperable QR code standard jointly developed by NPCI, Visa, Mastercard, and American Express. Merchants display QR codes that encode payment details, which consumers scan to initiate transactions. While BharatQR achieves interoperability across card networks, it still exposes merchant identifiers linked directly to accounts and does not normalize transactions across distinct settlement rails like UPI, NEFT, or IMPS.

### EPC QR Guidelines for SEPA Transfers

The European Payments Council has published specifications for QR-based SEPA credit transfers. These standards describe QR initiation of ISO 20022 credit transfer messages but remain tied to the SEPA framework and do not address multi-rail routing or real-time fallback.

d. Prior Art Patent Literature

US20140172531A1 (Performing transactions using QR codes)

Describes embedding purchaser and seller account data into QR codes for transaction initiation. While it teaches tokenized QR initiation, it fails to disclose rail selection, fallback, or ISO 20022 normalization.

### WO2014119963A1 (Instant Payment System and Method Using QR Codes)

Discloses merchant-presented QR codes containing transaction details. While it provides for QR-based initiation, it requires merchant exposure to transaction data and lacks rail-agnostic orchestration.

### US20170221066A1 (Real-Time Payment System Utilizing Prefunded Accounts)

Focuses on real-time interbank settlement using prefunded accounts. It addresses settlement finality but does not disclose merchant-facing APIs, tokenized identifiers, or QR-based initiation.

### US20230259915A1 (Cross-Service Peer-to-Peer Platforms)

References selecting among rails for cross-platform transfers and the use of QR identifiers in communications. However, the disclosure is limited to peer-to-peer contexts and does not describe merchant integration, ISO 20022 mapping, or compliance modules.

U.S. Pat. No. 8,725,576B2 (Remote Transaction Processing with Multiple Payment Methods)

Describes POS devices capable of handling different payment methods. While it provides flexibility at the terminal level, it does not address multi-rail orchestration or alias-based QR initiation.

### US20230133158A1 (Secure Financial Electronic Transactions)

Provides fallback mechanisms between e-check and credit card payments. While it anticipates fallback, it is limited to switching between payment instruments, not among multiple real-time settlement rails.

### 3. Shortcomings in Existing Solutions

Despite advances in RTP, FedNow, SCT Inst, BharatQR, and QR-based methods, significant limitations persist:

a. Rail Fragmentation and Lack of Abstraction

Each rail—FedNow, RTP, SEPA Instant—operates in isolation. Merchants and developers must integrate separately with each API. No existing solution discloses a unified API that normalizes transactions and routes across multiple rails.

b. No Dynamic Rail Selection with Fallback

Current systems cannot dynamically select the optimal rail based on cost, latency, or availability, nor can they provide seamless fallback. Prior art discloses fallback to a different instrument (e.g., e-check to card), not rail-to-rail routing.

c. Exposure of Sensitive Data in QR Systems

BharatQR and prior QR patents expose merchant or consumer account details within the code, or use tokenization without privacy safeguards. No system discloses alias-based QR codes with short-lived tokens that prevent counterparties from seeing raw account data.

d. Limited Standardization Across Rails

While FedNow and SCT Inst employ ISO 20022, these implementations are rail-specific. No art discloses a message conversion module that translates heterogeneous transaction inputs into ISO 20022 messages for use across multiple networks.

e. Compliance and Reconciliation as Afterthoughts

Existing systems generally apply AML, KYC, and sanctions checks in rail-specific or post-hoc manners. No integrated architecture performs in-line compliance and reconciliation across multiple rails within the same flow.

f. Merchant Hardware Costs

Legacy systems often require proprietary POS terminals. Even QR standards like BharatQR assume specialized display hardware. No art discloses a system where commodity displays, smartphones, or tablets suffice, reducing cost barriers for small merchants.

### Definitions

a. Payment rail: a settlement network endpoint that receives a payment message and effects clearing/settlement (e.g., FedNow, RTP, ACH).
b. Fallback: automatic retransmission of the same EndToEndId-identified payment message to an alternate rail when an acknowledgment is not received within 150 ms or when the computed availability score S<0.60.
c. Dynamic (one-time) alias token: a token generated for a single transaction with a time-to-live (TTL)≤30 seconds; becomes invalid after TTL or once consumed.
d. Availability/health score: S=0.5*(1-normalized latency)+0.3*(uptime)+0.2*(1-error rate), computed every 500 ms with an exponential moving average over 60 seconds.
e. Canonical object: an internal, rail-agnostic structure with fields {amount, payerAlias, payeeAlias, invoiceld, currency, metadata} used before ISO mapping.
f. Module or engine: instructions stored on a non-transitory computer-readable medium and executed by at least one processor.
g. Real-time: acknowledgment within 150 ms.

### SUMMARY OF THE INVENTION

The present invention provides systems and methods for conducting real-time digital payments across multiple settlement rails through a unified, rail-agnostic architecture. Unlike conventional systems that operate in silos, the invention introduces a multi-layer framework that abstracts rail-specific complexities, tokenizes sensitive account identifiers, and integrates compliance, security, and reconciliation directly into the transaction path.

At a high level, the invention addresses the shortcomings of legacy and contemporary payment infrastructures by:
Providing a single application programming interface (API) that normalizes and processes transactions across heterogeneous payment rails.
Employing dynamic, tokenized scannable codes, such as QR codes, that embed transaction metadata, including payment amounts, while shielding sensitive account credentials.
Converting all transactions into ISO 20022-compliant message formats or equivalent standardized schemas, ensuring interoperability, traceability, and regulatory alignment.
Implementing a rail selection and fallback engine that chooses an optimal rail based on latency, cost, and availability, and transparently reroutes the transaction if the selected rail fails.
Reducing barriers to adoption by allowing merchants to operate using commodity hardware, such as smartphones, tablets, and displays, without requiring dedicated point-of-sale equipment.

In exemplary embodiments, one or more processors (i) generate and validate a dynamic alias token of format nonce32∥RID∥ts∥HMAC-SHA256 with TTL≤30 seconds using an HSM; (ii) construct an ISO 20022 PACS.008.001.08 message by mapping canonical fields {amount→CdtTrfTxInf/Amt/InstdAmt, payerAlias→DbtrAcct/Id/Othr/Id, payeeAlias→CdtrAcct/Id/Othr/Id, invoiceld→RmtInf/Ustrd, e2e→PmtId/EndToEndId}; (iii) compute rail health scores S every 500 ms over a 60-second rolling window and trigger fallback if acknowledgment is not received within 150 ms or S<0.60; and (iv) embed machine-readable compliance clearance codes into SplmtryData/Envlp/Document. These operations enable concrete, technical improvements in interoperability, resiliency, and compliance.

### 1. Unified Rail-Agnostic API

Central to the invention is a unified API layer through which merchants and developers initiate transactions. Rather than integrating separately with FedNow, RTP, ACH, SEPA, or other rails, a merchant issues a single call to the API. The system then normalizes this request into a canonical transaction object. This approach:
Reduces integration costs for merchants and developers.
Ensures uniform treatment of transactions regardless of the underlying rail.
Provides flexibility to add new rails or payment channels without requiring code changes at the merchant side.

From the perspective of the end user, the unified API abstracts away the heterogeneity of the payment ecosystem, enabling the same merchant or consumer application to operate seamlessly across domestic, international, real-time, and deferred rails.

### 2. Dynamic Tokenized Scannable Codes

To initiate a payment, the system generates a dynamic scannable code (e.g., QR code, barcode, NFC tag, or equivalent). Unlike static identifiers, these codes are:
Transaction-specific: generated in real time for each payment.
Tokenized: containing only aliases or surrogates for actual account data.
Short-lived: expiring after use or a defined time interval to prevent replay attacks.

In certain embodiments, the scannable code includes not only the merchant alias but also the payment amount and currency code. For example, a merchant may generate a QR code representing a $25.63 transaction. When scanned, the consumer's application is presented with a prefilled, tokenized payment instruction, eliminating the need for manual entry.

This feature is particularly advantageous for small merchants, street vendors, or digital platforms, as it allows seamless transaction initiation without specialized POS terminals. By embedding amounts within the dynamic code, the invention provides a frictionless checkout experience while preserving security.

### 3. Standardized Messaging and ISO 20022 Normalization

Once a transaction request is initiated, the system employs a message-conversion engine to construct messages in ISO 20022 format or another standardized schema. This ensures:
Compatibility with FedNow, RTP, SEPA Instant, and other ISO 20022-compliant networks.
Simplified reconciliation, since ISO 20022 supports rich metadata fields for remittance, compliance, and auditing.
Regulatory alignment with financial reporting and anti-money-laundering standards.

For rails that are not natively ISO 20022-compliant, the system performs bi-directional translation between the canonical ISO 20022 object and the target rail's native message format. This allows a single merchant request to interoperate with multiple heterogeneous rails, each with differing technical requirements.

### 4. Rail Selection and Fallback

The invention introduces a rail orchestration engine that dynamically selects a settlement rail for each transaction. Criteria may include:
Latency: preference for real-time or near-real-time settlement.
Cost: preference for lower interchange or processing fees.
Availability: detection of outages or congestion in a rail.
Merchant or consumer preferences: e.g., preferring instant confirmation over lowest cost.

If a transaction cannot be completed via the initially selected rail, the orchestration engine executes automatic fallback, rerouting the same transaction through an alternate rail. This process is transparent to both merchant and consumer. For example, if FedNow is unavailable, the transaction may be routed via RTP, and if both are unavailable, through ACH as a deferred option.

This fallback mechanism ensures transaction resiliency, addressing a gap not disclosed in prior art that only provides fallback across different payment instruments (e.g., from e-check to card), not among multiple real-time settlement networks.

### 5. Security, Compliance, and Reconciliation

The system integrates compliance checks and fraud screening directly into the transaction flow. Unlike conventional systems, where AML, KYC, and sanctions checks are applied after settlement, the invention performs these checks in-line. The architecture includes:
Fraud detection modules that evaluate behavioral and transactional anomalies.
Sanctions screening against updated lists at the time of initiation.
Automated reconciliation based on ISO 20022 metadata, allowing merchants and financial institutions to maintain consistent ledgers without manual intervention.

This approach significantly reduces risk exposure and supports adoption in heavily regulated financial environments.

### 6. Minimal Merchant Hardware Requirements

A critical design principle of the invention is the elimination of specialized hardware dependencies. Merchants can generate and display dynamic scannable codes using Smartphones or tablets, Commodity digital displays, or even printed paper.

Consumers complete transactions using standard mobile devices equipped with cameras or NFC readers. By avoiding proprietary POS terminals, the invention lowers adoption barriers for small and medium-sized businesses, expanding access to real-time digital payments.

### 7. Extensibility and Future Applications

The architecture is modular, enabling future integrations, including:
Cross-border settlements with real-time currency conversion.
Blockchain-based rails or central bank digital currency (CBDC) integrations.
Smart contracts for conditional or escrowed payments.
AI-driven fraud detection based on evolving machine-learning models.

By anticipating these extensions, the system is positioned as a future-proof payment platform adaptable to emerging technologies and regulatory frameworks.

8. Distinction from Prior Art

The inventive combination of features distinguishes this system from existing solutions:
a. Unlike FedNow and RTP, the invention is not rail-specific; it provides a unified abstraction across multiple rails.
b. Unlike BharatQR and EPC QR standards, the invention employs dynamic, tokenized codes with embedded transaction amounts, preventing exposure of raw account data.
c. Unlike US20140172531A1 and WO2014119963A1, which disclose QR initiation but not rail orchestration, the invention integrates dynamic rail selection and fallback.
d. Unlike US20170221066A1, which focuses on prefunded interbank settlement, the invention provides merchant-facing APIs, ISO 20022 normalization, and in-line compliance.
e. Unlike US20230259915A1, which discusses cross-service P2P transfers, the invention addresses merchant and consumer interoperability across multiple rails with standardized reconciliation.

In certain embodiments, one or more processors: (i) map a canonical transaction object to ISO 20022 PACS.008.001.08 fields including CdtTrfTxInf/Amt/InstdAmt, DbtrAcct/Id/Othr/Id, CdtrAcct/Id/Othr/Id, RmtInf/Ustrd, and PmtId/EndToEndId; (ii) generate and validate a time-limited alias token for a party using an HSM-resident key, the token comprising nonce32∥RID∥ts∥HMAC-SHA256 ( . . . ) with TTL≤30 s; (iii) compute, at 500-ms intervals, per-rail health scores over a rolling 60-s window and trigger fallback when acknowledgment is absent within 150 ms or the score for the selected rail falls below 0.6; and (iv) embed a machine-readable compliance clearance code in CdtTrfTxInf/SplmtryData/Envlp/Document prior to each transmission. These concrete operations improve message delivery reliability while preventing duplicate settlements.

### BRIEF DESCRIPTION OF THE DRAWINGS

The accompanying drawings, which are incorporated herein and constitute part of this specification, illustrate exemplary embodiments of the invention and, together with the detailed description, serve to explain the principles of the invention.

FIG. 1 is a block diagram of the overall system architecture, illustrating the unified API layer, alias resolver, message conversion engine, rail orchestration engine, compliance modules, and settlement interfaces with multiple rails.

FIG. 2 is a flow diagram of a merchant-presented dynamic QR transaction, showing the generation of a scannable code with embedded amount, tokenized alias, and subsequent consumer scan.

FIG. 3 is a flow diagram of a consumer-presented code transaction, showing consumer-side QR generation, merchant scan, and orchestration through the unified API.

FIG. 4 is a message sequence chart illustrating ISO 20022 normalization and translation for transmission across different rails, including FedNow, RTP, and SEPA Instant.

FIG. 5 is a process flow illustrating dynamic rail selection and fallback, showing selection criteria (latency, cost, availability) and rerouting logic upon failure.

FIG. 6 is a compliance and reconciliation module diagram, illustrating integration of AML/KYC checks, sanctions screening, fraud scoring, and ISO 20022 reconciliation metadata.

FIG. 7 is a deployment diagram illustrating minimal merchant hardware requirements, including smartphones, tablets, displays, and paper-based QR codes.

FIG. 8 is a modular extension diagram showing potential future integrations, such as cross-border rails, blockchain rails, AI fraud detection, and smart contracts.

### DETAILED DESCRIPTION OF THE PREFERRED EMBODIMENTS

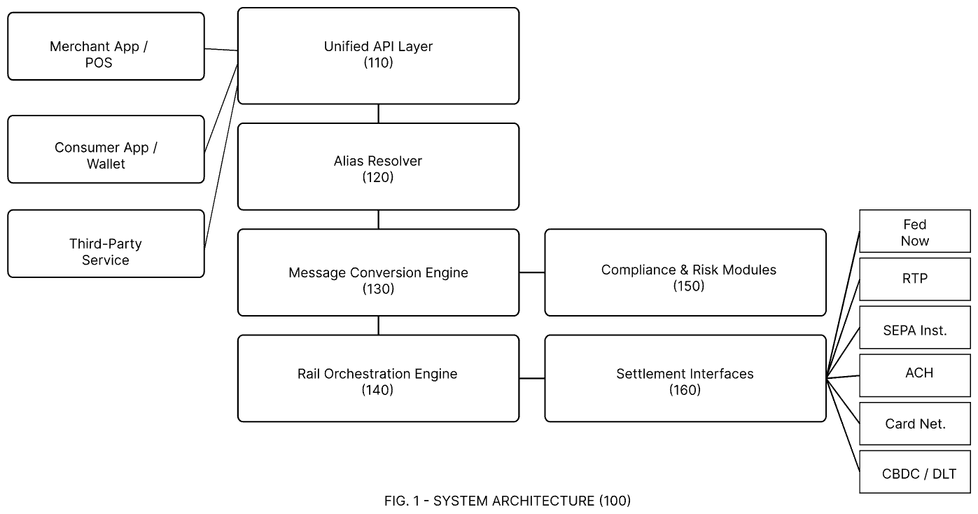

### FIG. 1—System Architecture

Referring now to FIG. 1, there is shown a block diagram of a payment processing system (100) constructed in accordance with preferred embodiments of the invention. The system (100) comprises a plurality of interconnected modules designed to facilitate real-time, rail-agnostic digital payments.

### Unified API Layer (110)

At the uppermost level, the system exposes a unified application programming interface (API) (110). The API serves as the entry point for merchant applications, consumer applications, or third-party service providers to initiate payment transactions. In exemplary embodiments, the API may be implemented as a set of RESTful endpoints, gRPC calls, or other programmatic interfaces, secured via OAuth2, mTLS, or equivalent authentication protocols.

The unified API (110) abstracts the complexity of disparate settlement rails by accepting transaction requests in a canonical schema. Each request may include:
Merchant alias identifier (tokenized),
Consumer identifier (if available),
Transaction amount,
Currency code,
Optional metadata (invoice number, timestamp, compliance flags).

By standardizing input, the API allows merchants to avoid separate integrations with FedNow, RTP, SEPA Instant, ACH, or future networks.

### Alias Resolver (120)

The system further comprises an alias resolver (120), which securely maps tokenized or surrogate identifiers to underlying account credentials. The alias resolver maintains a mapping database that stores associations between merchant aliases and bank account information (e.g., routing number, account number, IBAN). In certain embodiments, the alias may be a one-time-use token generated dynamically for each transaction, thereby minimizing replay attacks. In other embodiments, aliases may be reusable but stored in a vault with hardware security modules (HSMs) enforcing access control. The alias resolver ensures that merchants never gain visibility into consumers' raw account credentials, and vice versa, thereby preserving privacy.

In certain embodiments, the alias token has the format:

$$Token = nonce 32 ‖ RID ‖ ts ‖ HMAC - SHA 256 ( k , nonce 32 ‖ RID ‖ ts ) ,$$

where RID is a 96-bit rail-independent alias, ts is a timestamp, and k is an HSM-resident secret key. Each token is valid for a maximum time-to-live (TTL) of 30 seconds. Validation fails if now-ts>30 seconds, or if clock skew exceeds 2 seconds. The alias mapping table is encrypted at rest using AES-GCM under a data-encryption key (DEK) that is wrapped by an HSM master key. Keys are rotated at least every 90 days, and key identifiers (kid) are stored in token metadata for validation.

### Message Conversion Engine (130)

The message conversion engine (130) translates the canonical API request into an ISO 20022-compliant message or other standard financial messaging format. ISO 20022 is preferred due to its global adoption and ability to carry rich metadata fields.

The conversion engine may:
Map transaction amount to InstdAmt elements,
Map merchant alias to CdtrAcct identifiers,
Attach reconciliation references to RmtInf structures,
Embed compliance attributes (e.g., KYC flag, sanctions flag).

For non-ISO-native rails (e.g., legacy ACH), the engine performs bi-directional translation between ISO 20022 and the rail's native schema, ensuring interoperability.

### Rail Orchestration Engine (140)

A rail orchestration engine (140) determines the settlement path for each transaction. The engine evaluates criteria such as:
Latency—preferring real-time rails (FedNow, RTP, SEPA Instant) over deferred rails (ACH).
Cost—minimizing merchant service fees.
Availability—detecting outages, congestion, or downtime.
Regulatory compliance—choosing rails authorized for certain transaction types (e.g., cross-border).

If the primary rail is unavailable, the engine performs automatic fallback, rerouting the transaction to an alternate rail. For example, a payment initiated via FedNow may be transparently rerouted to RTP if FedNow nodes are unreachable.

### Compliance and Risk Modules (150)

The compliance and risk module (150) performs in-line screening and fraud detection. Unlike conventional systems, where checks are performed post-settlement, the invention integrates these functions directly into the transaction path. Modules may include:
AML/KYC screening,
Sanctions list checks,
Fraud scoring models (e.g., velocity checks, anomaly detection),
Transaction monitoring for suspicious patterns.
Screening results may be embedded in ISO 20022 fields for downstream auditability.

### Settlement Interfaces (160)

Finally, the system interfaces with settlement rails (160), including but not limited to FedNow, RTP, SEPA Instant, ACH, card networks, or future digital currency rails (CBDCs, blockchain). Each rail integration is modular, allowing plug-and-play configuration as new networks become available.

### Operation of System Architecture

In operation, the system (100) executes a sequence of steps as follows:
1. Transaction Initiation-Merchant or consumer application invokes the unified API with the alias and transaction amount.
2. Alias Resolution-Alias resolver maps identifiers to account credentials securely.
3. Message Conversion-Conversion engine constructs an ISO 20022 message.
4. Rail Selection—The Orchestration engine evaluates criteria and selects a settlement rail.
5. Compliance Screening-Transaction screened for AML/KYC/sanctions/fraud.
6. Settlement Execution-Transaction transmitted via the chosen rail.
7. Confirmation & Reconciliation-Settlement confirmation sent to merchant and consumer applications, with reconciliation metadata attached.

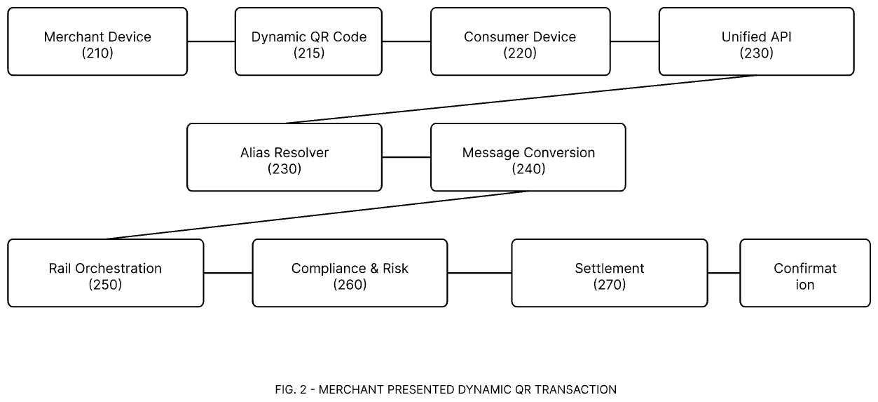

### FIG. 2—Merchant-Presented Dynamic QR Transaction

Referring now to FIG. 2, there is shown a process flow illustrating a merchant-presented, dynamic scannable code embodiment of the invention. This embodiment demonstrates how a merchant can generate a transaction-specific QR code containing a tokenized alias and an embedded payment amount, and how a consumer can complete the transaction by scanning the code.

### Merchant Device and Dynamic Code Generation (210)

In preferred embodiments, a merchant device (210), which may include a smartphone, tablet, point-of-sale terminal, or desktop computer, is configured to invoke the unified API (FIG. 1, element 110) to request the generation of a dynamic scannable code. The API call may include:
A merchant alias identifier (previously registered with the alias resolver),
The transaction amount and currency code,
Optional transaction metadata such as invoice number, product identifier, or
geolocation data,
A time-to-live (TTL) parameter specifying code validity duration (e.g., 30 seconds, 2 minutes).

Upon receipt of this request, the system generates a transaction-specific token representing the merchant alias and amount. This token is encapsulated in a scannable code (215), preferably a QR code, although in alternative embodiments, barcodes, NFC tags, Bluetooth payloads, or other equivalent technologies may be used.

The dynamic code is displayed on the merchant device's screen or printed on paper. In certain embodiments, the code may include error correction levels (e.g., QR code ECC Level M or higher) to ensure reliability in variable lighting or scanning conditions.

### Consumer Scan and Transaction Initiation (220)

A consumer device (220), typically a smartphone with a camera-enabled payment application, scans the dynamic QR code. Upon scanning, the application extracts the tokenized alias and embedded transaction amount.

The consumer device then presents the transaction details for user confirmation, displaying:
Merchant name or identifier (resolved through the alias directory),
Transaction amount (pre-filled),
Optional metadata (e.g., invoice number).

This approach eliminates manual entry of sensitive data or amounts, reducing human error and improving security.

Upon confirmation, the consumer device transmits a payment initiation request via a secure channel (e.g., TLS-encrypted HTTPS call) to the unified API (110).

### API Normalization and Alias Resolution (230)

The unified API receives the payment initiation request, verifies authentication credentials, and normalizes the transaction into a canonical format.

The alias resolver (120) resolves the merchant alias embedded in the QR code into underlying settlement credentials, such as account number, routing number, IBAN, or wallet identifier. Critically, these details are never exposed to the consumer or merchant, but are securely handled within the system.

In some embodiments, alias resolution occurs via a distributed ledger or federated identity system, enabling cross-border alias mapping while maintaining data privacy.

### Message Conversion and ISO 20022 Mapping (240)

The normalized transaction object is then passed to the message conversion engine (130), which constructs a financial message in compliance with ISO 20022.

For example:
The transaction amount is mapped to InstdAmt,
The merchant alias is mapped to a masked CdtrAcct element,
The consumer account is mapped to DbtrAcct (masked if alias-based),
Reconciliation metadata is inserted into RmtInf fields.

If the target settlement rail is not ISO-native (e.g., ACH), a translation layer converts between ISO 20022 and the rail's native format.

### Rail Selection and Fallback (250)

The rail orchestration engine (140) evaluates available rails (e.g., FedNow, RTP, SEPA Instant, ACH) against predefined criteria:
Latency—if consumer and merchant require real-time finality, preference is given to instant rails.
Cost—if fees are a priority, a lower-cost rail may be chosen even with slower settlement.
Availability—real-time monitoring ensures that if a rail is congested or offline, alternate rails are considered.

If the initial rail fails, the system automatically reroutes the transaction to a fallback rail, preserving the consumer's payment experience without requiring manual re-entry.

### Compliance and Risk Screening (260)

Before transmission to the settlement rail, the compliance and risk module (150) performs in-line screening, including:
Sanctions list checks (e.g., OFAC, EU lists),
AML/KYC validation,
Fraud detection scoring (velocity, unusual transaction patterns, device fingerprinting).

If the transaction is flagged, it may be delayed, rejected, or routed to a manual review queue. If cleared, the transaction proceeds to settlement.

### Settlement and Confirmation (270)

The transaction is transmitted to the selected settlement rail (160). Upon execution, the settlement confirmation is received and relayed back through the unified API to both the merchant and consumer applications.

The merchant device displays confirmation of funds irrevocably credited, while the consumer device displays confirmation of funds successfully debited. Both devices may also receive reconciliation metadata (e.g., reference numbers) for record-keeping.

### Advantages of Merchant-Presented Dynamic QR Embodiment

This embodiment provides multiple technical and commercial benefits:
Seamless experience—consumer sees pre-filled amount and merchant details, reducing input errors.
Privacy—sensitive account credentials are masked through aliasing.
Security—dynamic, short-lived tokens prevent replay and mitigate fraud.
Resilience—rail fallback ensures transaction continuity.
Accessibility—merchants need only a display device or printer, eliminating costly hardware investments.

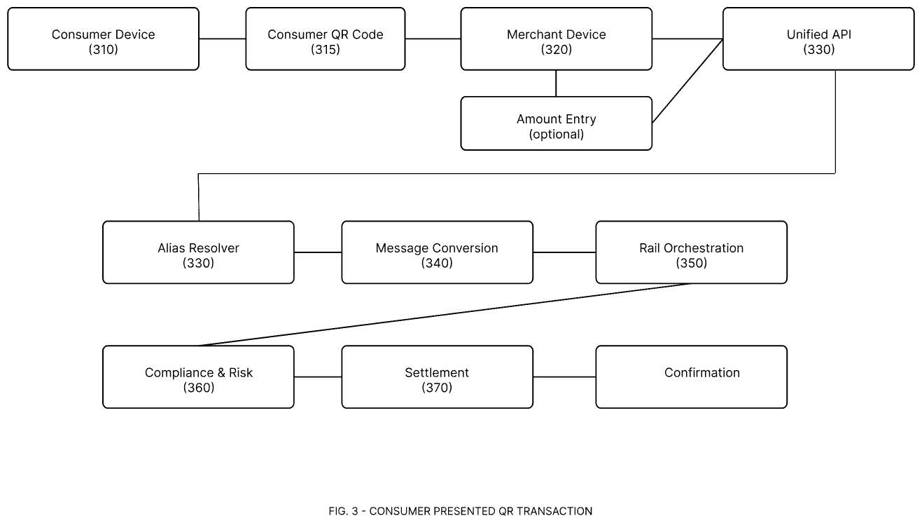

### FIG. 3—Consumer-Presented QR Transaction

Referring now to FIG. 3, there is shown a process flow illustrating a consumer-presented scannable code embodiment of the invention. In this embodiment, the consumer device generates a dynamic QR (or equivalent) code containing a tokenized alias and transaction details, which is then scanned by the merchant device to initiate payment.

### Consumer Device and Dynamic Code Generation (310)

In this embodiment, a consumer device (310), typically a smartphone with a wallet or banking application, invokes the unified API to generate a transaction-specific scannable code (315).

The API request may include:
Consumer alias identifier (mapped to underlying debit account),
Transaction amount (if consumer pre-selects amount), or a blank field for merchant entry,
Optional metadata (transaction purpose, geolocation, device fingerprint),
Validity parameters (e.g., code expiration within 60 seconds).

The system responds with a dynamic token, encapsulating the consumer alias and transaction parameters. This token is rendered on the consumer device as a QR code (315). In alternative embodiments, the code may be a barcode, NFC payload, Bluetooth beacon, or other equivalent scannable form.

The consumer displays this code to the merchant at checkout.

### Merchant Scan and Transaction Initiation (320)

A merchant device (320), equipped with a camera, scanner, or NFC reader, scans the dynamic consumer-presented code. Upon scan, the merchant device application decodes the tokenized alias and any included transaction parameters.

Two scenarios are supported:
a. Amount Included: If the consumer pre-selected or embedded the amount, the merchant simply reviews and confirms the transaction request.
b. Amount Not Included: The merchant is prompted to enter the transaction amount, which is then bound to the decoded consumer alias before submission.

In both cases, the merchant application transmits a payment initiation request to the unified API (110).

### API Normalization and Alias Resolution (330)

Upon receipt, the unified API normalizes the request into a canonical transaction object.

The alias resolver (120) resolves the consumer alias to settlement credentials (e.g., account number, routing number, IBAN). Importantly, the merchant never gains visibility into these credentials; only the system handles the resolution.

In some embodiments, consumer aliases may be rotating identifiers, periodically refreshed to prevent long-term correlation and protect privacy.

### Message Conversion and ISO 20022 Mapping (340)

The message conversion engine (130) constructs an ISO 20022 payment initiation message:
Consumer alias→mapped to DbtrAcct field (debtor account).
Merchant alias→mapped to CdtrAcct field (creditor account),
Amount (if applicable)→mapped to InstdAmt,
Metadata (invoice, reference)→mapped to RmtInf.

For non-ISO rails, translation occurs into the rail's native message schema, ensuring cross-rail interoperability.

### Rail Selection and Fallback (350)

The rail orchestration engine (140) evaluates criteria and selects the optimal rail. For example:
If FedNow is available, the payment is routed via FedNow for real-time settlement.
If FedNow is down, the payment is rerouted via RTP.
If both instant rails are down, fallback occurs to ACH or SEPA deferred rails.

The orchestration engine ensures that consumers and merchants experience continuity of service, regardless of underlying rail availability.

### Compliance and Risk Screening (360)

Before execution, the compliance and risk module (150) performs in-line checks:
Sanctions screening (both consumer and merchant aliases).
Fraud detection (unusual merchant/consumer pairing, transaction velocity).
AML/KYC validation.

This module ensures that compliance requirements are satisfied at the time of initiation, not after settlement.

### Settlement and Confirmation (370)

The transaction is transmitted via the chosen settlement rail (160). Settlement confirmation flows back through the unified API.

The merchant device (320) receives confirmation of credit, the consumer device (310) receives confirmation of debit, and both parties receive reconciliation metadata for auditability.

### Advantages of Consumer-Presented QR Embodiment

This embodiment provides unique advantages:
Consumer privacy—the consumer controls the generation of the tokenized code.
Flexibility—works in both “pre-filled” and “merchant-filled” amount scenarios.
Rail abstraction—no need for merchant systems to integrate separately with multiple rails.
Hardware simplicity—merchants need only a scanning-capable device, not specialized terminals.

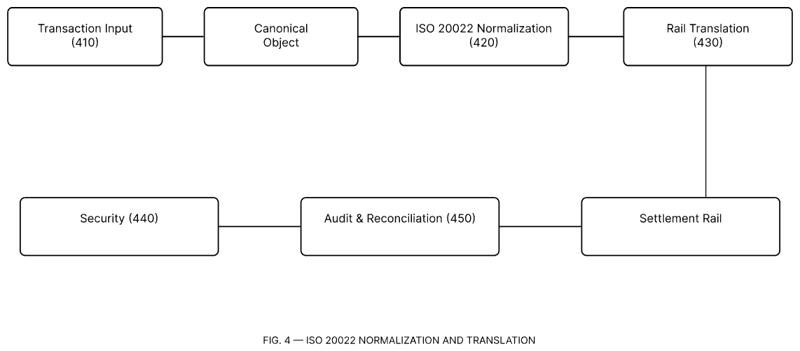

FIG. 4—ISO 20022 Normalization & Translation

Referring now to FIG. 4, there is shown a message-level workflow in which transaction inputs are normalized into ISO 20022-compliant structures, translated as necessary for specific rails, and transmitted securely to financial institutions for settlement.

### Transaction Input and Canonical Object Formation (410)

The process begins with the receipt of a transaction input from either a merchant device, a consumer device, or a third-party service provider integrated via the unified API (110). The input may contain:
Tokenized alias identifiers for payer and payee,
Transaction amount and currency code,
Metadata such as invoice reference, geolocation, device identifiers,
Compliance flags, e.g., whether a consumer has already passed KYC.

The unified API normalizes this into a canonical transaction object. In certain embodiments, the canonical object is structured as JSON or XML with fields mapped to ISO 20022 semantics.

### ISO 20022 Normalization Engine (420)

The normalized object is then processed by the ISO 20022 normalization engine (420). This engine maps fields from the canonical object into ISO 20022 message structures, such as PAIN.001 (customer credit transfer initiation) or PACS.008 (FI-to-FI customer credit transfer).

Exemplary field mappings include:

| | |
|---|---|
| Canonical field | → ISO 20022 PACS.008.001.08 field |
| amount | → CdtTrfTxInf/Amt/InstdAmt |
| payerAlias | → DbtrAcct/Id/Othr/Id |
| payeeAlias | → CdtrAcct/Id/Othr/Id |
| invoiceld | → RmtInf/Ustrd |
| e2e (transaction ID) | → PmtId/EndToEndId |
| complianceCode | → CdtTrfTxInf/SplmtryData/Envlp/Document |

For non-ISO rails:

| | |
|---|---|
| ACH: map InstdAmt | → Entry Detail Record, Ustrd → Addenda 05. |
| Card/ISO 8583: map amount | → DE4, alias → tokenPAN, e2e → DE48 private field. |

In some embodiments, the normalization engine may insert cryptographic hashes of alias mappings into unused ISO 20022 fields, ensuring auditability without exposing raw account data.

### Rail-Specific Translation (430)

Once an ISO 20022 message is constructed, the system determines whether the target rail natively supports ISO 20022.

FedNow and RTP: Already ISO 20022-compliant; the normalized message is transmitted directly.

SEPA Instant: Also ISO 20022-compliant; however, requires region-specific fields (e.g., BIC, IBAN). The system auto-inserts these from the alias resolver.

ACH (U.S.): Not fully ISO 20022-compliant. The system translates the ISO message into NACHA formats. For example:

InstdAmt → Entry Detail Record Amount,
RmtInf/Ustrd → Addenda Record.

Card Networks: If integration is required, ISO 20022 fields are mapped into ISO 8583 or ISO 7816 structures, with alias tokens serving as masked PAN surrogates.

This translation capability ensures that merchants and consumers only see one consistent API behavior, regardless of the technical requirements of the underlying rails.

### Security and Integrity of Messages (440)

The normalization engine includes security measures to ensure message integrity:
a. Digital Signatures—each normalized ISO 20022 message may be signed with the system's private key, allowing recipient institutions to verify authenticity. In certain embodiments, each PACS.008 message is signed using ECDSA P-256. Rail endpoints verify the signature using the system's published public key. Sensitive fields such as alias mappings may also be encrypted at the element level with JSON Web Encryption (JWE). Replay protection is enforced by rejecting duplicate EndToEndId values within a 120-second rolling window.
b. Encryption—sensitive fields (alias mappings, amounts) may be encrypted at the element level using XML Encryption or JSON Web Encryption.
c. Replay Prevention—each message includes unique transaction identifiers and timestamps to prevent duplicate processing.

### Audit and Reconciliation Metadata (450)

A unique feature of the invention is the embedding of reconciliation metadata directly in ISO 20022 messages. For example:

Transaction Reference ID → EndToEndld,
Merchant Invoice Number → RmtInf/Ustrd,
Compliance Decision Codes → SplmtryData extensions.

This allows financial institutions and merchants to reconcile transactions automatically, without requiring manual matching across disparate systems.

### Operation of ISO Normalization & Translation Workflow

In operation, the flow is as follows:
1. Receive Input—Merchant or consumer initiates transaction via unified API.
2. Form Canonical Object—Input normalized into structured, rail-agnostic object.
3. Map to ISO 20022—Fields inserted into standardized message structures.
4. Translate (if required)—For non-ISO rails, conversion to native formats.
5. Transmit Securely—Digitally signed and encrypted message sent to selected rail.
6. Reconcile—Metadata preserved for settlement confirmation and audit.

### Advantages of ISO Normalization & Translation

This module confers several benefits not disclosed in prior art:
True interoperability—Any transaction can be processed across ISO and non-ISO rails seamlessly.
Regulatory alignment—ISO 20022 fields support AML, sanctions, and audit data natively.
Future proofing—As more rails adopt ISO 20022, merchants need no additional integration effort.
Fraud prevention—Tokenized identifiers plus ISO metadata reduce risk of credential exposure.

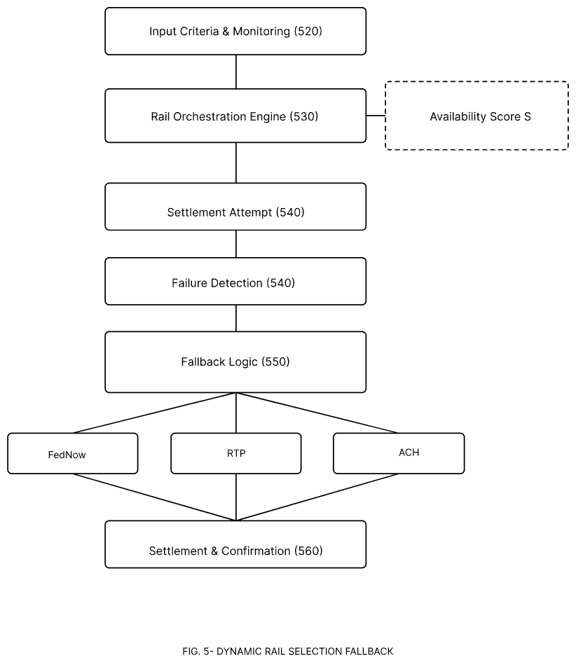

### FIG. 5—Dynamic Rail Selection & Fallback

Referring now to FIG. 5, there is shown a flow diagram of the rail orchestration engine (510), which dynamically selects the optimal settlement rail for a given transaction and automatically reroutes the transaction to an alternate rail upon failure of the initially selected rail.

### Input Criteria and Monitoring (520)

The orchestration process begins with the evaluation of input criteria (520). These criteria may be configured by default policies, merchant preferences, consumer preferences, or dynamic system monitoring. Criteria may include:
Latency Requirements: For example, an e-commerce merchant may specify that payments must be completed with <2 seconds of settlement latency.
Cost Constraints: Merchants may prefer lower-fee rails when transaction size exceeds a threshold.
Availability: Real-time monitoring modules track uptime and congestion metrics of each rail, ensuring only healthy rails are considered.
Regulatory Compliance: Certain rails may be restricted by jurisdiction (e.g., SEPA vs FedNow), requiring rules-based routing.
Currency and Region: In cross-border flows, selection is limited to rails supporting the given currency pair.

Monitoring modules may use APIs, health pings, or integration with network status dashboards to continuously update the orchestration engine's decision set.

### Rail Orchestration Engine (530)

The rail orchestration engine (530) executes a deterministic or weighted decision algorithm to select the settlement rail. In exemplary embodiments, this may involve:
a. Priority Ordering: Rails ranked by pre-defined priority (e.g., FedNow>RTP>ACH).
b. Weighted Scoring: Each rail scored on latency, cost, and availability metrics, with the highest scoring rail selected.
c. Machine Learning Models: In some embodiments, reinforcement learning or predictive analytics may optimize rail choice based on historical performance patterns.

In exemplary embodiments, the rail orchestration engine executes a deterministic algorithm for rail scoring and fallback. Telemetry from each candidate rail is collected every 500 ms, including average latency (ms), error rate (%), and uptime (%). A numeric availability score S is computed for each rail as:

$$S = 0.5 * ( 1 - normalized latency ) + 0.3 * uptime + 0.2 * ( 1 - error rate ) .$$

Each score is smoothed using an exponential moving average (EMA) over a rolling 60-second window. The highest scoring rail is selected as the primary. If no acknowledgment is received from the primary within 150 milliseconds, or if S (primary) falls below 0.60, the system automatically retransmits the same EndToEndId-identified PACS.008 message to the alternate rail with the next-highest score. To prevent duplicate settlements, reconciliation metadata (EndToEndId and SplmtryData) is preserved across retries.

The orchestration engine produces a selection output, which is passed to the message conversion engine (FIG. 4, element 420) for formatting into a rail-specific schema.

### Settlement Attempt and Failure Detection (540)

Once the rail is selected, the system attempts settlement. The failure detection module (540) monitors acknowledgments and error codes.

Failure may be indicated by:
Timeouts—no response within expected SLA.
Negative Acknowledgment—rail rejects transaction.
Network Error—communication link unavailable.
Regulatory Flag—transaction blocked due to compliance restrictions.

Upon failure detection, the transaction object is returned to the orchestration engine with a failure state flag.

### Fallback Logic and Alternate Rail Routing (550)

The fallback module (550) evaluates alternate rails and reroutes the transaction. Key aspects include:
Seamless Continuity: The consumer and merchant are not required to re-enter transaction details.
Preservation of Metadata: All compliance and reconciliation metadata travels with the transaction across fallback attempts.
Retry Limits: In some embodiments, fallback attempts are limited (e.g., maximum 2 retries) to prevent looping.
Graceful Downgrade: If no real-time rails are available, transaction may downgrade to deferred settlement (e.g., ACH), while notifying both parties.

For example, if a consumer initiates a $50 transaction via a merchant QR code, the system may first attempt FedNow. If FedNow returns a timeout, the system immediately reroutes to RTP. If RTP is congested, fallback may occur to ACH with explicit notification that settlement will be delayed.

### Settlement and Confirmation (560)

Once a rail successfully completes settlement, confirmation is returned through the unified API to both merchant and consumer devices. In embodiments, the confirmation explicitly identifies which rail was used (e.g., “Settled via RTP”), providing transparency without requiring technical understanding.

### Advantages of Dynamic Rail Selection and Fallback

This embodiment provides several novel advantages:
Resilience: Ensures that transactions succeed even during partial network outages.
Optimization: Merchants and consumers benefit from cost and latency-optimized routing.
Transparency: Both parties may be informed of which rail executed the settlement, supporting trust.
Extensibility: As new rails (e.g., CBDCs, blockchain networks) emerge, the orchestration engine can incorporate them seamlessly.
   Distinction from Prior Art
1. FedNow and RTP provide real-time settlement but do not disclose fallback between rails.
2. US20230133158A1 discloses fallback between payment instruments (e.g., e-check to card), not between settlement rails.
3. WO2014119963A1 discloses QR initiation but no orchestration layer.
4. No known prior art teaches a unified orchestration engine that selects and reroutes across multiple real-time settlement rails while maintaining ISO 20022 normalization and tokenized alias privacy.

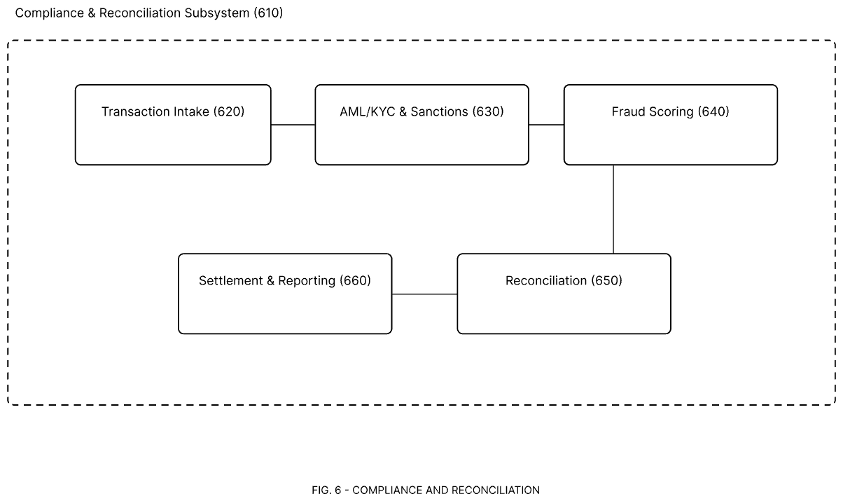

### FIG. 6—Compliance & Reconciliation Modules

Referring now to FIG. 6, there is shown a block diagram of the compliance and reconciliation subsystem (610) integrated into the payment processing system. This subsystem ensures that every transaction is screened, risk-assessed, and reconciled in real time, before or during settlement.

### Transaction Intake (620)

The compliance and reconciliation flow begins with transaction intake (620). At this stage, the canonical transaction object (as described in FIG. 4) is enriched with metadata relevant to compliance checks, including:
Payer alias and underlying financial institution (masked but resolvable),
Payee alias and institution,
Transaction amount and currency,
Geographic origin and destination,
Device and session identifiers.

This intake module ensures that the compliance subsystem receives a complete set of attributes without exposing raw credentials to either merchant or consumer.

### AML/KYC & Sanctions Screening (630)

The first processing module is the AML/KYC and sanctions screening engine (630). This engine operates in real time, querying internal and external databases.

AML/KYC: Validates that both payer and payee aliases are linked to previously verified accounts (e.g., through identity verification records or bank onboarding processes).

Sanctions Screening: Compares transaction participants against updated sanctions lists, such as OFAC (U.S.), EU consolidated list, or UN lists.

Jurisdictional Rules: Ensures compliance with region-specific regulations (e.g., PSD2 in the EU, FFIEC guidelines in the U.S.).

If a match or high-risk flag is detected, the transaction may be blocked, routed to a manual review queue, or subjected to enhanced due diligence procedures.

### Fraud Detection and Behavioral Scoring (640)

The second module is the fraud detection and scoring engine (640). In preferred embodiments, fraud detection uses a hybrid model of rules and supervised machine learning. Features include:
Transaction velocity (transactions per minute),
Geographical distance between payer and payee,
Device fingerprint entropy,
Merchant category code (MCC) risk levels,
Amount z-score relative to merchant historical distribution.
Comparison to baseline transaction patterns for given consumers or merchants.

The machine learning model may be a gradient-boosted decision tree trained on labeled transaction data, retrained weekly, with a target area-under-curve (AUC)≥0.93. Thresholds are calibrated to maintain≤0.5% false positives. Transactions above a high-risk threshold are blocked; medium-risk transactions may be routed to a slower rail with two-factor authentication; low-risk transactions proceed normally. The decision outcome is embedded as a machine-readable compliance code in the SplmtryData field.

### Reconciliation Module (650)

Following compliance and fraud checks, the reconciliation module (650) ensures that all transactions can be properly matched across financial institutions and merchant records.
Metadata Embedding: The module embeds reconciliation identifiers directly into ISO 20022 fields (e.g., EndToEndId, RmtInf).
Automated Matching: On settlement, confirmation messages are automatically matched to originating requests using these identifiers.
Ledger Updates: Both merchant-side and system-side ledgers are updated in near real time, reducing reconciliation errors.

This module eliminates the need for merchants to manually reconcile batch statements, a pain point in legacy ACH and card-based systems.

### Settlement and Reporting (660)

Once a transaction clears compliance and fraud checks, it proceeds to settlement (660) via the chosen rail. Simultaneously, audit and compliance logs are updated.
Regulatory Reporting: In certain embodiments, transaction details are automatically submitted to regulators (e.g., Suspicious Activity Reports, PSD2 transaction logs).
Merchant Reporting: Merchants may receive enriched settlement confirmations, including compliance clearance codes.
Consumer Transparency: Consumers may optionally receive notifications confirming compliance validation, increasing trust in the transaction process.

### Operation of Compliance & Reconciliation Flow

In operation, the sequence proceeds as follows:
1. Transaction Intake—Canonical object enriched with compliance attributes.
2. AML/KYC & Sanctions Check—Validate identities, screen against global watchlists.
3. Fraud Scoring—Assign risk score based on velocity, geography, device, and behavioral models.
4. Reconciliation Metadata—Insert identifiers into ISO 20022 fields for automated matching.
5. Settlement Execution—Transaction routed via selected rail with compliance clearance code.
6. Audit & Reporting—Logs and regulatory submissions updated in parallel.

Advantages of Integrated Compliance & Reconciliation

This subsystem provides several key benefits:
Real—Time Screening—Unlike legacy systems, compliance occurs before or during settlement, not days later.
Lower Risk Exposure—Suspicious transactions are blocked early, reducing liability for merchants and banks.
Regulatory Alignment—ISO 20022 fields leveraged for seamless regulatory reporting.
Operational Efficiency—Automated reconciliation reduces manual back-office processes.
Consumer & Merchant Trust—Transparent compliance confirmation improves confidence in digital payments.
   Distinction from Prior Art
1. FedNow and RTP require participants to perform their own compliance checks externally; neither discloses an in-line compliance subsystem.
2. BharatQR and EPC QR frameworks focus on initiation, not compliance integration.
3. US20170221066A1 and US20230259915A1 discuss settlement models but not integrated reconciliation with ISO metadata.
4. No known prior art describes a unified system where AML/KYC, fraud detection, sanctions screening, and reconciliation are embedded within a multi-rail orchestration framework.

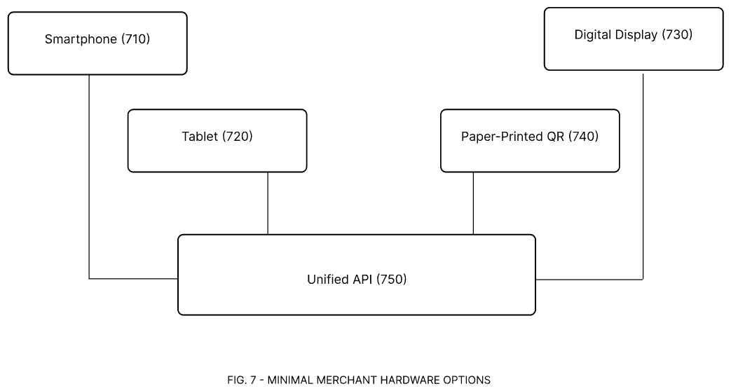

### FIG. 7—Minimal Merchant Hardware Deployment

Referring now to FIG. 7, there is shown a block diagram of exemplary merchant hardware configurations supported by the payment processing system. Unlike legacy card-based systems requiring dedicated point-of-sale (POS) terminals or NFC readers, the present invention enables merchants to participate using commodity hardware such as smartphones, tablets, digital displays, or even paper-printed QR codes.

### Smartphone Deployment (710)

In one embodiment, the merchant operates solely through a smartphone (710). The smartphone may:
Run a merchant application integrated with the unified API,
Generate dynamic scannable codes on demand for each transaction,
Display codes on the device screen for consumers to scan,
Receive settlement confirmations via the application.

This mode is particularly suited for small businesses, street vendors, and service professionals, eliminating the need for dedicated terminals.

### Tablet Deployment (720)

In another embodiment, the merchant uses a tablet (720). A larger screen size supports:
Enhanced display of scannable codes,
Parallel management of multiple transactions,
Integration with inventory and order-management applications.

The tablet embodiment is ideal for restaurants, retail counters, or other environments where merchants handle higher transaction volumes.

### Digital Display Deployment (730)

In a further embodiment, the merchant uses a dedicated digital display (730) such as an LED or LCD monitor. This display may:
Show dynamic scannable codes generated by the unified API,
Refresh automatically for each new transaction or invoice,
Integrate with an electronic cash register or ordering system.

This configuration supports semi-automated retail environments, where consumers scan display codes without direct merchant involvement.

### Paper-Printed QR Deployment (740)

In another embodiment, the merchant uses static QR codes printed on paper (740). Static Codes represent a reusable merchant alias, allowing consumers to enter amounts on their devices.

This embodiment supports offline initiation scenarios, where merchants lack stable internet connectivity but can still provide scannable codes. Transactions sync once connectivity is restored. For offline initiation, the system issues dynamic codes containing signed initiation intents with a TTL≤2 minutes. When a consumer device submits the intent upon reconnection, the system checks for duplicates by hashing (RID, amount, ts) and comparing against prior EndToEndId entries. Only the first valid submission within the 2-minute window is processed; later duplicates are rejected, ensuring idempotency and preventing replay.

### Unified API Integration (750)

All of the foregoing hardware configurations connect via the unified API (750). The API ensures that:
The merchant experience remains consistent across hardware types.
Alias resolution, ISO normalization, compliance, and rail orchestration occur identically in the backend.
Settlement confirmations and reconciliation metadata flow back to the merchant device, regardless of form factor.

Thus, whether a merchant uses a smartphone, tablet, display, or paper printout, the system operates seamlessly.

### Advantages of Minimal Hardware Deployment

This embodiment provides several technical and commercial benefits:
Low Cost of Entry—Merchants can begin accepting payments without purchasing dedicated terminals.
Hardware Flexibility—The system supports a wide range of devices, ensuring accessibility in diverse markets.
Scalability—Merchants can upgrade from paper to digital displays to tablets without changing backend integration.
Offline Readiness—Printed codes allow transactions to be initiated even when connectivity is intermittent.
Global Reach—By removing dependency on proprietary terminals, adoption barriers in developing economies are reduced.
   Distinction from Prior Art
1. Card-based POS terminals (e.g., Verifone, Ingenico) require dedicated hardware and cannot operate on commodity devices.
2. BharatQR and EPC QR focus on QR initiation but do not disclose unified API integration across multiple merchant hardware types.
3. US20160269252A1 discloses QR-based payments but assumes dedicated reader hardware, not commodity smartphones or paper deployment.
4. The present invention uniquely combines multi-rail orchestration, alias/tokenization, and hardware flexibility, making it both novel and broadly enabling.

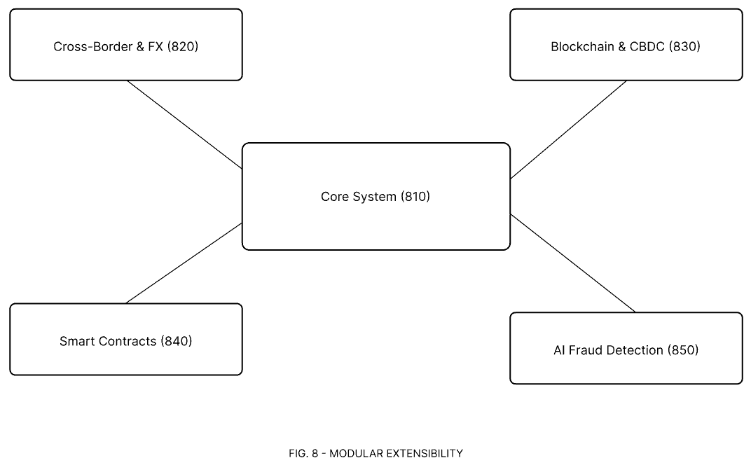

### FIG. 8—Modular Extensibility of the Payment System

Referring now to FIG. 8, there is shown a block diagram illustrating the core system (810) and multiple extensibility modules (820-850). The design demonstrates how the invention is implemented in a modular architecture such that new capabilities may be added without disrupting existing merchant and consumer integrations.

### Core System (810)

The core system (810) comprises the previously described modules:
Unified API (FIG. 1, element 110),
Alias resolver (120),
ISO 20022 normalization engine (130),
Rail orchestration engine with fallback (140, FIG. 5),
Compliance and reconciliation modules (FIG. 6).

The core system guarantees that regardless of extensions, transactions always flow through a standardized, rail-agnostic backbone. This ensures backward compatibility with merchant and consumer devices.

### Cross-Border Rails & Foreign Exchange Module (820)

In one embodiment, the system may be extended to support cross-border settlement rails such as SWIFT gpi, SEPA cross-border, or new bilateral corridors.
a. Currency Conversion: A foreign exchange (FX) engine integrated with the orchestration layer may perform real-time conversion.
b. Dual Settlement Messaging: ISO 20022 messages enriched with FX data are split into domestic legs for each jurisdiction.
c. Regulatory Handling: Country-specific data retention and compliance rules are respected through modular compliance adapters.

This module enables the invention to scale beyond domestic FedNow/RTP rails into global interoperability.

### Blockchain and CBDC Integration Module (830)

In another embodiment, the system may incorporate blockchain-based settlement rails or central bank digital currencies (CBDCs).
a. Blockchain Rails: Transactions may be wrapped in smart contract calls, with ISO 20022 messages mapped to blockchain payloads.
b. CBDCs: Central bank-issued tokens (e.g., Fed-issued digital dollar) may be treated as another rail in the orchestration engine.
c. Interoperability: Alias tokens may represent blockchain wallet addresses, ensuring merchants and consumers do not directly handle private keys.

This ensures that as CBDCs emerge globally, the invention can route payments seamlessly across both fiat and digital-native rails.

### Smart Contracts & Escrow Module (840)

In some embodiments, the system may support smart contract-based flows:
Conditional Payments: Funds released only when predefined conditions are met (e.g., delivery confirmed, escrow expiration).
Escrow Accounts: Alias tokens mapped to escrow wallets controlled by the system.
Programmable Settlement: ISO 20022 metadata extended to include smart contract references, linking payment initiation to on-chain conditions.

This enables trust-minimized transactions, expanding use cases into e-commerce, supply chains, and high-value B2B payments.

AI-Driven Fraud Detection & ML Models (850)

In further embodiments, the fraud detection module (FIG. 6, element 640) may be extended with artificial intelligence models.
Predictive Models: Neural networks predicting fraud likelihood based on behavioral data.
Adaptive Thresholds: Machine learning dynamically adjusting risk scores.
Collaborative Networks: Federated learning models trained across multiple financial institutions without sharing raw customer data.

This creates a self-learning fraud defense layer, far more advanced than static rule-based systems.

### Operation of Modular Extensions

The extensibility framework operates as follows:
1. Transaction enters the core system (810) through unified API.
2. Alias, ISO normalization, and compliance performed as in baseline flows.
3. Extension modules invoked selectively:
   a. FX module if cross-border,
   b. Blockchain module if CBDC rail selected,
   c. Smart contract module if conditional logic required,
   d. AI fraud module if risk score requested.
4. Transaction routed to final rail and confirmed.

Each extension operates independently but integrates seamlessly with the unified core, preserving the rail-agnostic, alias-secured design.

### Advantages of Modular Extensibility

Future-Proof Design: System adapts to evolving rails (CBDCs, blockchain).
Scalable Innovation: New modules plug in without breaking existing merchant integrations.
Regulatory Agility: Modules handle jurisdiction-specific compliance without altering core.
AI Integration: The System continuously improves fraud detection accuracy over time.
Market Expansion: Supports domestic, cross-border, fiat, and digital-native payments within one framework.
   Distinction from Prior Art
1. BharatQR and EPC QR do not disclose modular architecture for blockchain or AI extension.
2. FedNow and RTP do not address cross-border or programmable payments.
3. US20230123456A1 (example blockchain settlement patent) focuses solely on blockchain, without unified rail-agnostic orchestration.
4. The invention uniquely combines QR/token-based initiation, ISO normalization, rail fallback, and extensible modules; no prior art teaches this integration.

### Claim-to-Figure Mapping

The following descriptions illustrate how the appended claims are supported by the accompanying drawings (FIGS. 1-8). Each mapping demonstrates the correspondence between claimed elements and the disclosed embodiments, ensuring written description and enablement under 35 U.S.C. § 112(a).

### INDEPENDENT CLAIMS

### Claim 1 (System).

(i) Receiving a transaction request containing a dynamic alias token with a time-to-live (TTL) ≤30 seconds and validating against a hardware security module (HSM) is illustrated in FIG. 1 (Alias Resolver 120).
(ii) Constructing an ISO 20022 payment message and embedding a compliance-clearance code is shown in FIG. 4 (Normalization Engine 420, SplmtryData insertion).
(iii) Computing availability scores every 500 ms is illustrated in FIG. 5 (Rail Orchestration Engine 530, scoring computation).
(iv) Transmitting the message to a primary rail and rerouting upon failure while preserving reconciliation metadata is illustrated in FIG. 5 (Failure Detection 540 and Fallback Module 550).
(v) Returning settlement confirmation identifying the rail used is illustrated in FIG. 2 (Settlement & Confirmation 270) and FIG. 3 (Settlement & Confirmation 370).

### Claim 12 (Method).

(i) Canonical transaction intake via a unified API is illustrated in FIG. 1 (Unified API 110).
(ii) Alias resolution of payer and payee identifiers is illustrated in FIG. 1 (Alias Resolver 120).
(iii) ISO 20022 message formation is shown in FIG. 4 (Normalization Engine 420).
(iv) Rail selection and scoring logic are shown in FIG. 5 (Input Criteria 520, Orchestration Engine 530).
(v) Failure detection and automatic fallback are shown in FIG. 5 (Failure Detection 540, Fallback 550).
(vi) Settlement confirmation returning to merchant and consumer is shown in FIG. 2 (270) and FIG. 3 (370).

### Claim 18 (Computer-Readable Medium).

(i) The stored instructions correspond to the operations shown in FIG. 1 through FIG. 5, specifically generation and validation of alias tokens, ISO 20022 mapping, rail selection and fallback, and confirmation return.

### DEPENDENT CLAIMS

Claim 2: Alias token format and HSM validation: FIG. 1 (120, token structure detail).
Claim 3: Dynamic QR code generation with offline deduplication: FIG. 2 (Dynamic Code 215, Offline flow); FIG. 7 (Paper QR 740).
Claim 4: ISO 20022 field mapping and cross-rail translation: FIG. 4 (420, mapping table).
Claim 5: Rail fallback preference ordering: FIG. 5 (530, selection and retry logic).
Claim 6: Embedding base64-encoded compliance codes: FIG. 4 (SplmtryData insertion).
Claim 7: Hybrid fraud detection models: FIG. 6 (Fraud Detection 640).
Claim 8: Key rotation and AES-GCM encryption: FIG. 1 (120, encrypted alias mapping).
Claim 9: Digital signatures and replay prevention: FIG. 4 (Security & Integrity 440).
Claim 10: Replay protection via EndToEndId time window: FIG. 4 (440, replay prevention logic).
Claim 11: Exponential moving average (EMA) smoothing of availability score: FIG. 5 (530, scoring computation).
Claim 13: Consumer-presented dynamic QR codes: FIG. 3 (Consumer Device 310, QR 315).
Claim 14: ISO 20022 to NACHA/ISO 8583 translation: FIG. 4 (Rail-Specific Translation 430).
Claim 15: Sanctions screening: FIG. 6 (AML/KYC & Sanctions Engine 630).
Claim 16: Fraud scoring features including geolocation and device fingerprinting: FIG. 6 (Fraud Detection 640).
Claim 17: Reconciliation metadata embedding and automated matching: FIG. 6 (Reconciliation Module 650).
Claim 19: In-line compliance clearance and metadata embedding: FIG. 6 (Compliance Flow 620-630).
Claim 20: Modular extensions for blockchain, CBDCs, smart contracts, and AI fraud detection: FIG. 8 (Modules 820-850).

### Advantages of the Invention

The present invention provides significant advantages over conventional payment infrastructures and existing real-time payment schemes. Unlike FedNow, RTP, SEPA Instant, BharatQR, or the systems described in prior art references, the disclosed system introduces a combination of features that collectively yield technical improvements in interoperability, resiliency, compliance, and merchant accessibility.

### 1. Rail-Agnostic Interoperability

Existing real-time rails, such as FedNow, RTP, and SEPA Instant, require direct integration by each merchant or financial institution. BharatQR and EPC QR schemes enable QR-based initiation but remain tied to regional networks. By contrast, the present invention employs a unified API and ISO 20022 normalization engine, enabling a single integration to operate seamlessly across multiple rails, including ISO-native and legacy non-ISO systems. This significantly reduces integration cost and complexity while future-proofing merchant systems.

2. Dynamic Rail Selection with Automatic Fallback

No known prior art or deployed system provides an orchestration engine with automatic rail fallback. FedNow and RTP function independently, and merchants must choose one rail. If a network is unavailable, transactions fail. The invention uniquely provides real-time monitoring and rerouting among multiple rails, including deferred networks, blockchain rails, or central bank digital currencies. Unlike FedNow and RTP, which operate independently and fail upon outage, the disclosed Rail Orchestration Engine (FIG. 5) computes an availability score S every 500 ms over a 60-second window and reroutes transactions if acknowledgments exceed 150 ms or if S (primary)<0.60. This deterministic fallback ensures uninterrupted transaction continuity and materially reduces failure rates.

### 3. Integrated Compliance and Fraud Screening

In conventional systems, compliance checks (AML, KYC, sanctions) are performed post-settlement or externally by financial institutions. The present invention integrates compliance in-line with the transaction flow, embedding clearance codes and reconciliation identifiers directly into ISO 20022 fields. Fraud detection is also enhanced through a hybrid model of heuristic rules and machine learning, improving detection accuracy while minimizing false positives. This integration reduces compliance overhead and enhances regulatory trust.

### 4. Privacy Through Alias and Tokenization

Most existing systems expose or require raw account details during transaction initiation. BharatQR, for example, often transmits merchant account identifiers in the clear. The disclosed system employs a tokenized alias resolver that ensures account credentials are never exposed to counterparties. Dynamic, one-time-use tokens further prevent replay attacks, thereby materially improving transaction security.

5. Dynamic Scannable Codes with Embedded Amounts

While QR-based systems exist, they typically rely on static codes that require manual entry of transaction amounts. The invention introduces dynamic scannable codes (QR, NFC, Bluetooth, RFID) with embedded transaction amounts and expiration windows, ensuring faster, error-free, and more secure consumer experiences.

### 6. Minimal Merchant Hardware Requirements

Legacy card networks and even many QR frameworks require specialized terminals or certified readers. The disclosed system supports initiation using only commodity hardware such as smartphones, tablets, digital displays, or even paper-printed codes. This reduces cost barriers for small and medium enterprises and enables adoption in low-resource environments.

### 7. Extensible Modular Architecture

The invention is designed to evolve with emerging technologies. Cross-border FX modules, blockchain settlement rails, central bank digital currencies, smart contract escrow, and AI-based fraud detection may be integrated without altering the merchant interface. No existing real-time rail or QR framework discloses a comparable modular architecture for extensibility.

### CONCLUSION/BOILERPLATE DISCLAIMER

Accordingly, the foregoing embodiments are illustrative only and not limiting. Variations, substitutions, and equivalents that perform substantially the same functions in substantially the same way are deemed within the scope of the appended claims. For example, although QR codes are illustrated as exemplary scannable media, the same alias token format and ISO 20022 mapping may be embedded in NFC payloads, Bluetooth beacons, RFID tags, or future machine-readable carriers. Similarly, while ISO 20022 PACS.008.001.08 is disclosed as the preferred format, the same canonical-to-message mapping may be adapted to NACHA, ISO 8583, ISO 7816, or future distributed ledger schemas. The scope of protection is defined solely by the appended claims.

1. A computing system comprising at least one processor and a non-transitory memory storing instructions that, when executed, cause the processor to:
(i) receive, from a merchant or consumer device, a transaction request comprising a dynamic, one-time alias token having the format nonce32∥RID∥ts∥HMAC-SHA256 (k,nonce32∥RID∥ts) and a time-to-live of no more than 30 seconds, and validate the token against an HSM-sealed alias mapping;
(ii) construct an ISO 20022 PACS.008.001.08 payment message by mapping canonical transaction fields including {amount→CdtTrfTxInf/Amt/InstdAmt, payerAlias→DbtrAcct/Id/Othr/Id, payeeAlias→CdtrAcct/Id/Othr/Id, invoiceId→RmtInf/Ustrd, e2e→PmtId/EndToEndId}, and embed a machine-readable compliance-clearance code into CdtTrfTxInf/SplmtryData/Envlp/Document;
(iii) compute, for each candidate settlement rail, an availability score S every 500 ms over a rolling 60-second window based on latency, timeout, and error-rate telemetry;
(iv) transmit the payment message to a primary settlement rail and, if an acknowledgment is not received within 150 milliseconds or if S(primary)<0.60, automatically retransmit the same EndToEndId-identified message to an alternate rail while preserving RmtInf and SplmtryData integrity; and
(v) return a settlement confirmation identifying the rail used.

2. The system of claim 1, wherein the tokenized alias identifier comprises the format nonce32∥RIDIts∥HMAC-SHA256 (k,nonce32∥RID∥ts), has a time-to-live of no more than 30 seconds, and is validated against a hardware security module (HSM).

3. The system of claim 1, wherein the transaction request is initiated using a quick response (QR) code rendered with error-correction level M or higher, the QR code embedding both the alias token and the transaction amount, expiring within the TTL of the token, and wherein the merchant device comprises a smartphone, tablet, display, or paper-printed medium, with offline initiation supported by storing signed initiation intents and deduplicating upon reconnection using EndToEndId and HMAC.

4. The system of claim 1, wherein the message conversion engine generates an ISO 20022 PACS.008.001.08 payment message by mapping {amount→CdtTrfTxInf/Amt/InstdAmt; payerAlias→DbtrAcct/Id/Othr/Id; payeeAlias→CdtrAcct/Id/Othr/Id; invoiceId→RmtInf/Ustrd; e2e→PmtId/EndToEndId}, and translates into NACHA, ISO 8583, or ISO 7816 when the target settlement rail is non-ISO-native.

5. The system of claim 1, wherein the fallback module is configured to retransmit the same EndToEndId-identified message sequentially among multiple rails, with a preference order of FedNow, RTP, SEPA Instant, and ACH, and wherein downgrade to ACH occurs only after two failed attempts on instant rails.

6. The system of claim 1, wherein the compliance module embeds a base64-encoded type-length-value (TLV) compliance clearance code into CdtTrfTxInf/SplmtryData/Envlp/Document prior to transmission.

7. The system of claim 1, wherein the fraud detection module computes features including transaction velocity, geodistance, device fingerprint entropy, and merchant category code risk, and applies a hybrid rules-based and machine learning model with a false-positive target of ≤0.5%.

8. The system of claim 1, wherein the alias resolver uses an HSM-resident key for token validation, rotates keys every 90 days with key identifiers, and encrypts the alias mapping table at rest using AES-GCM under an HSM-wrapped data-encryption key.

9. The system of claim 1, further comprising digitally signing the ISO 20022 PACS.008.001.08 message with ECDSA P-256 prior to transmission, wherein a recipient rail endpoint verifies the signature using a published public key.

10. The system of claim 1, wherein replay protection is enforced by rejecting any transaction request with a duplicate EndToEndId value received within a rolling 120-second window.

11. The system of claim 1, wherein the availability score S is smoothed using an exponential moving average (EMA) over the rolling 60-second window to dampen transient telemetry spikes.

12. A computer-implemented method comprising:
(a) receiving, at a unified application programming interface (API), a transaction request including a dynamic alias token of format nonce32∥RID∥ts∥HMAC-SHA256 with time-to-live ≤30 seconds, and validating the token against a key stored in a hardware security module (HSM);
(b) constructing an ISO 20022 PACS.008.001.08 payment message by mapping canonical transaction fields to {amount→CdtTrfTxInf/Amt/InstdAmt, payeeAlias→CdtrAcct/Id/Othr/Id, payerAlias→DbtrAcct/Id/Othr/Id, invoiceId→RmtInf/Ustrd, e2e→PmtId/EndToEndId}, and embedding a compliance-clearance code in SplmtryData/Envlp/Document;
(c) computing, for each settlement rail, an availability score S every 500 ms over a rolling 60-second window from telemetry;
(d) transmitting the payment message to a primary settlement rail, and if acknowledgment is not received within 150 ms or S (primary)<0.60, automatically retransmitting the same EndToEndId-identified message to an alternate settlement rail while preserving PmtId/EndToEndId and CdtTrfTxInf/SplmtryData; and
(e) returning a settlement confirmation that identifies the settlement rail used.

13. The method of claim 12, further comprising generating a dynamic scannable code including a tokenized alias and transaction amount, and setting a time-to-live validity window for the code.

14. The method of claim 12, wherein generating the payment message comprises constructing an ISO 20022 PACS.008.001.08 or PAIN.001 message, and translating the message into rail-specific schemas when required.

15. The method of claim 12, further comprising rerouting the payment message among multiple settlement rails, including at least one real-time rail and one deferred rail, with EndToEndId preserved across reroutes, and the returned confirmation explicitly identifies the settlement rail on which settlement was completed.

16. The method of claim 12, further comprising embedding a compliance clearance code, reconciliation reference, and merchant invoice identifier into the payment message.

17. The method of claim 12, further comprising performing fraud detection using both heuristic rules and adaptive machine learning models.

18. A non-transitory computer-readable medium storing instructions that, when executed by at least one processor, cause the processor to perform the method of claim 12, including:
(i) generating and validating a dynamic alias token of format nonce32∥RID∥ts∥HMAC-SHA256 with TTL≤30 seconds using an HSM;
(ii) constructing an ISO 20022 PACS.008.001.08 message by mapping fields {InstdAmt, DbtrAcct/Id/Othr/Id, CdtrAcct/Id/Othr/Id, RmtInf/Ustrd, PmtId/EndToEndId};
(iii) embedding a compliance-clearance code into SplmtryData/Envlp/Document;
(iv) computing health scores every 500 ms over a rolling 60-second window;
(v) retransmitting to an alternate rail if ack>150 ms or S<0.60 while preserving reconciliation metadata; and
(vi) returning a settlement confirmation identifying the rail used.

19. The medium of claim 18, wherein the instructions further cause the processors to generate a dynamic scannable code, construct an ISO 20022 message, reroute the message across multiple settlement rails, and perform in-line compliance screening prior to settlement execution.

20. The medium of claim 18, wherein the instructions further cause the processors to invoke modular extensions including blockchain integration, central bank digital currencies, smart contract escrow, or AI-driven fraud detection.
